(19) United States
(12) Patent Application Publication
(10) Pub. No.: US 2017/0024677 A1
(43) Pub. Date: Jan. 26, 2017

(54) System for Improving Management Performance

(71) Applicant: Service Guard Insurance Agency, L.P., Austin, TX (US)

(72) Inventors: Martin Jenns, Austin, TX (US); Anusha Vijayakumar, Austin, TX (US)

(73) Assignee: Service Guard Insurance Agency, L.P., Austin, TX (US)

(21) Appl. No.: 15/218,439

(22) Filed: Jul. 25, 2016

Related U.S. Application Data
(60) Provisional application No. 62/196,593, filed on Jul. 24, 2015.

(51) Int. Cl. G06Q 10/06; G06F 17/27; G06F 17/30

(52) U.S. Cl. CPC G06Q 10/06395; G06F 17/30867; G06F 17/3053; G06F 17/272; G06F 17/30203

(57) ABSTRACT

A participating manager will receive an invitation to participate in a moderated session conducted via a virtual or face-to-face classroom environment utilizing a management application's dynamic dashboard data visualization tool. The managers are ranked and compared according to sales performance. The moderator identifies who is above and below average based on PRU. The moderator may also present a Penetration screen showing product penetration and product per retail unit and a Revenue screen from which the managers will be able to view the revenue share/mix, the group revenue share/mix, the revenue source by product penetration, and the recent vs. previous quarter average profit. The information provided during the moderated sessions provides each manager with greater insight into where their performance ranks among their peers and facilitates improvement in the capabilities and profitability of finance managers.

This non-provisional application claims priority based upon prior U.S. Provisional Patent Application Ser. No. 62/196,593 filed Jul. 24, 2015 in the names of Martin Jenns and Anusha Vijayakumar, entitled “System for Improving Management Performance,” the disclosure of which is incorporated herein in its entirety by reference as if fully set forth herein.

### SUMMARY

A system and method are presented for improving the performance of finance managers, wherein a participating manager will receive an invitation to participate in a moderated session conducted via a virtual or face-to-face classroom environment, utilizing the management application's dynamic dashboard data visualization tool. Throughout the moderated session, the managers are ranked and compared according to his or her sales performance. The moderator identifies who is above and below average based on PRU and may identify a top performer based on similar information. The moderator may also present a Group Average screen to show results in a comparative manner.

The moderator may then present a Penetration screen showing product penetration and product per retail unit (PPRU). The monitor may elect to compare various products which provides valuable information regarding the relative penetrations of the products within the market. The moderator may direct the manager attendees to a Revenue screen from which the managers will be able to view the revenue share/mix, the group revenue share/mix, the revenue source by product penetration, and the recent vs. previous quarter average profit.

The information provided during the moderated sessions provides each manager with greater insight into where their performance ranks among their peers, allows them to engage in conversation regarding the data presented by the management application, and encourages them to become a more well-balanced, capable finance manager and profitable contributor to their company.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### DESCRIPTION OF THE DRAWINGS

For a more complete understanding of the present invention, and the advantages thereof, reference is now made to the following descriptions taken in conjunction with the accompanying drawings, in which:

FIG. 1 is a flow diagram showing the workflow of one embodiment of the management tool of the present invention from the user's perspective;

FIG. 2 is a flow diagram showing the workflow of one embodiment of the management tool of the present invention from the monitor's perspective;

FIG. 3 depicts a sample screen shot of the PRU screen for a top producer;

FIG. 4 depicts a sample screen shot of the PRU screen for a group of financial and insurance producers;

FIG. 5 depicts a sample screen shot of the Penetration screen for a single product;

FIG. 6 depicts a sample screen shot of the Product Penetration screen for a group of producers;

FIG. 7 depicts a sample screen shot of the Revenue screen; and

FIG. 8 is a flow diagram showing the backend data flow for one embodiment of the present invention.

### DESCRIPTION OF THE PREFERRED EMBODIMENTS

The present invention is directed to an improved system for improving management performance. The configuration and use of the presently preferred embodiments are discussed in detail below. It should be appreciated, however, that the present invention provides many applicable inventive concepts that can be embodied in a wide variety of contexts other than determination of energy content and detection of contaminants in a fluid stream. Accordingly, the specific embodiments discussed are merely illustrative of specific ways to make and use the invention, and do not limit the scope of the invention.

Also, reference is made below to the figures wherein like structures will be provided with like reference designations. It is understood that the figures are diagrammatic and schematic representations of some embodiments of the invention, and are not limiting of the present invention, nor are they necessarily drawn to scale.

Various embodiments of the present invention reveal where finance managers are performing well or struggling and communicates, via a moderator and a data visualization tool, where the managers can improve their performance. The disclosed methods and systems allows finance managers to identify training opportunities by uncovering their struggles and under-performing areas based on a statistical comparison within a selected peer group.

The novel aspects of the present invention include (1) aggregating finance managers' performance data across a unique and variable group, (2) ranking and comparing finance managers on an individual basis, based on, for example, the most recent full quarter's performance and comparing those metrics to the previous full quarter of data, (3) revealing, through a moderated session, the finance managers' greatest opportunities for growth, (4) revealing, through a moderated session, the most appropriate training opportunities individual finance managers should seek out in order to improve their skills, and (5) isolating very specific areas of training that the individual finance manager should focus on in order to become more effective.

By way of example, a user may be a finance manager for a dealership that sells financial product offerings. In some cases, the user may be a manager at more than one dealership within the same dealer group, in which case all sales data will be aggregated together.

There are at least two ways the moderated session may be conducted. First, the manager may be part of a virtual moderated session, where the manager and several other finance managers from the same dealer group are ranked and compared utilizing the sales data displayed on a dashboard screen within the program being used to conduct the session.

Alternatively, the manager may be a part of a virtual moderated session, where the manager and several other managers from different dealer groups are ranked and compared utilizing the sales data displayed in a dashboard screen within the program being used to conduct the session. If this is the case, the manager will be assigned a unique identifier in order to mask the managers' actual names. This allows for competing dealer groups to review competitors' data in an anonymous environment.

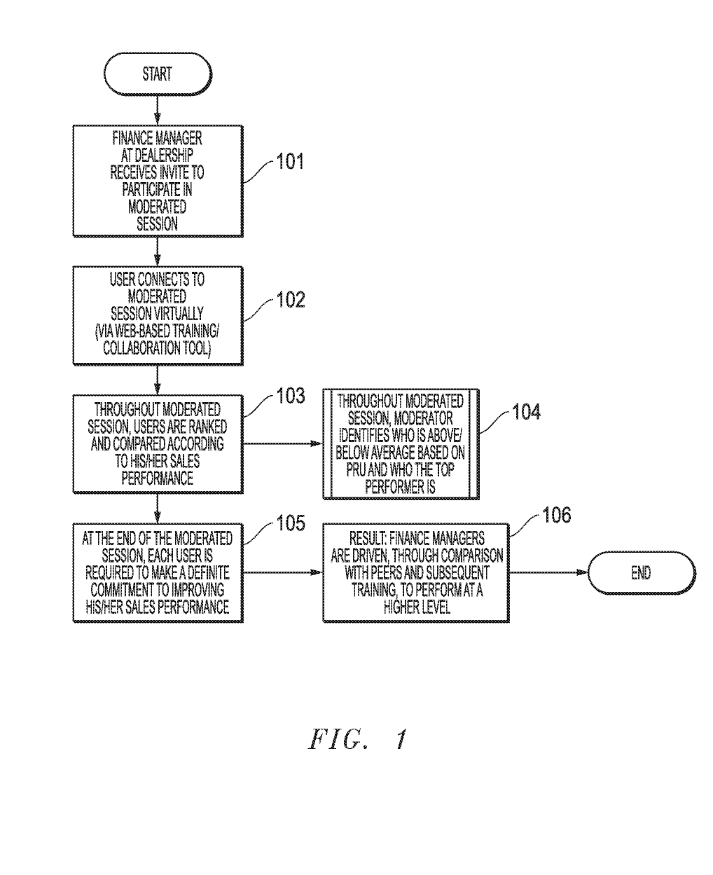

Referring now to FIG. 1, the participating manager will receive an invitation 101 with a link and/or phone number to dial in to the moderated session where they will be able to view the management application from their own PC or laptop. The moderated session is conducted via a virtual environment 102, utilizing the management application's dynamic dashboard data visualization tool to establish a base from which to engage the participants throughout the session. The virtual moderated sessions are hosted online via an online collaboration tool, such as, for example, GoToMeeting. In some embodiments, the moderated sessions may be hosted in a face-to-face classroom environment.

Throughout the moderated session, the managers are ranked and compared according to his or her sales performance 103. The moderator identifies who is above and below average based on PRU 104. The moderator also identifies the top performer. At the end of the moderated session, each manager may be required to make a definitive commitment to improving his or her sales performance 105. The information provided during the moderated sessions provides each manager with greater insight into where their performance ranks among their peers 106, allows them to engage in conversation regarding the data presented by the management application, and encourages them to become a more well-balanced, capable finance manager and profitable contributor to their company.

More specifically, the managers' participation in moderated sessions will assist them in identifying strengths and weaknesses among their peer groups which, in turn, will lead to additional training opportunities that will increase their effectiveness as a finance manager. All of these benefits will generate more profit for the dealership and more income for the finance manager.

The moderators, sometimes called trainers, involved in the training will have an in-depth knowledge of finance and insurance income development and the manager attendees' product offerings. The moderators will guide attendees (users) through the management application in order to increase the managers' knowledge of their sales performance over a certain period, for example the most recent full quarter as compared to the previous full quarter.

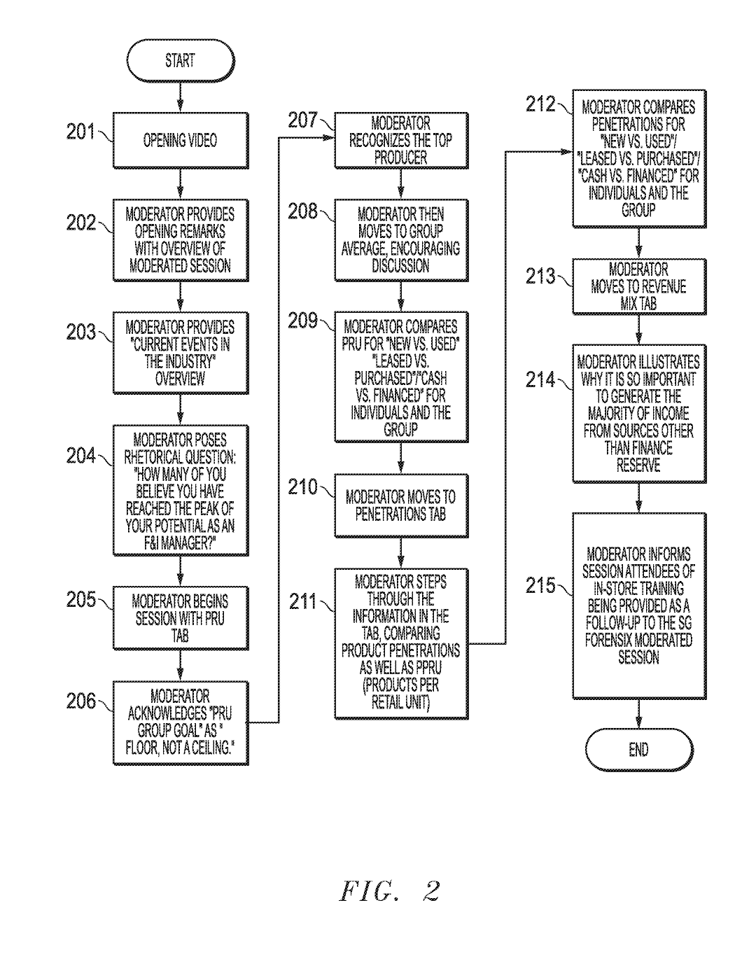

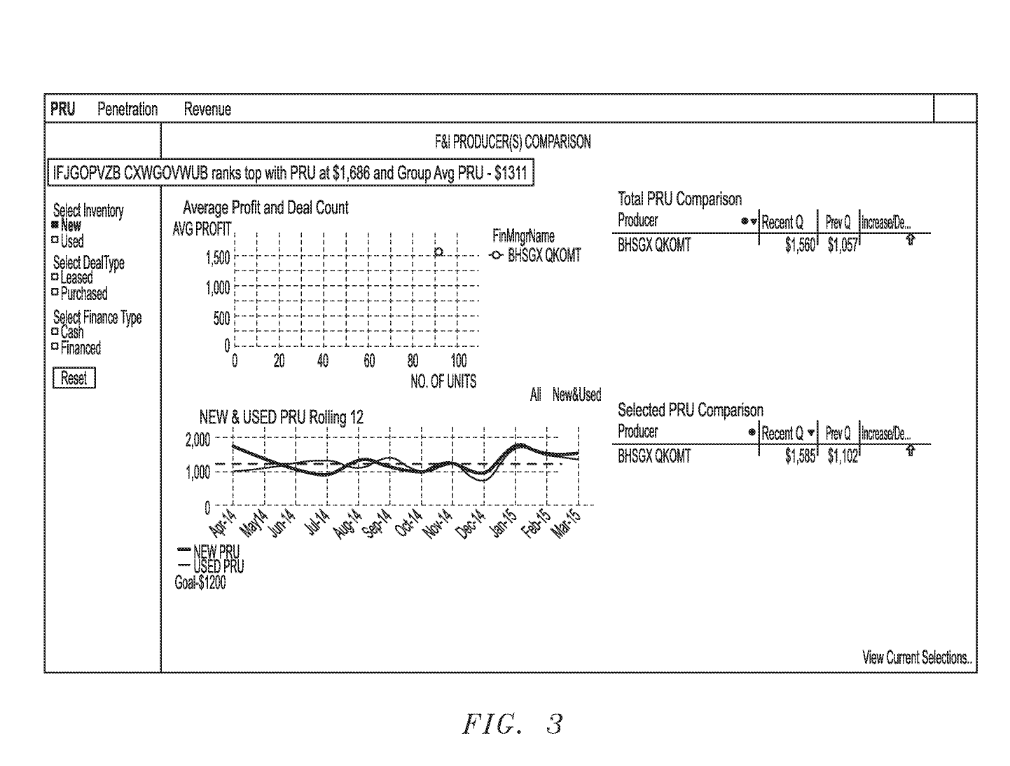

Referring now to FIG. 2, during moderated session, the moderator may begin by providing opening remarks including an overview of the moderated session 202 and current events within the industry 203. The moderator will then direct the manager attendees to the PRU screen 205, a sample of which is shown in FIG. 3, which recognizes the top producer 207. On the PRU screen, the information can be sorted based on new or used inventory, lease or purchase transactions or cash or finance transactions. Information is provided regarding the average profit and deal count and the difference in production between two periods.

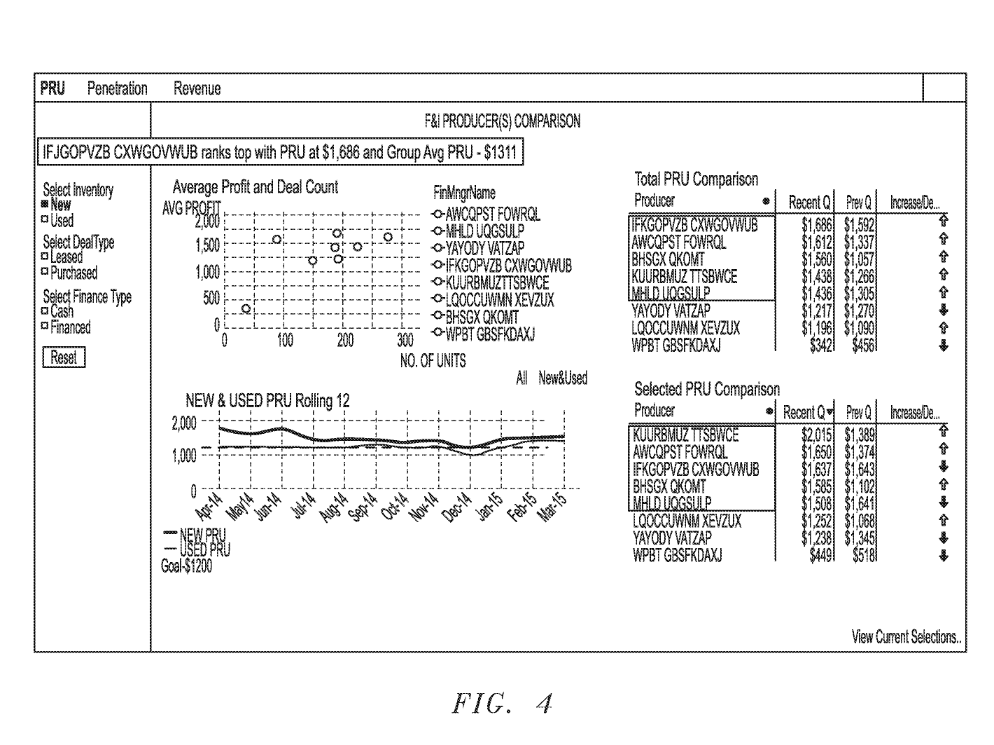

The moderator can then move to the Group Average screen 208, a sample of which is shown in FIG. 4. The Group Average screen provides similar information and has similar alternatives available as the top producer screen, but presents the information in a comparative manner. The moderator can compare the managers' relative performance in the new or used, leased or purchased, or cash or financed categories 209.

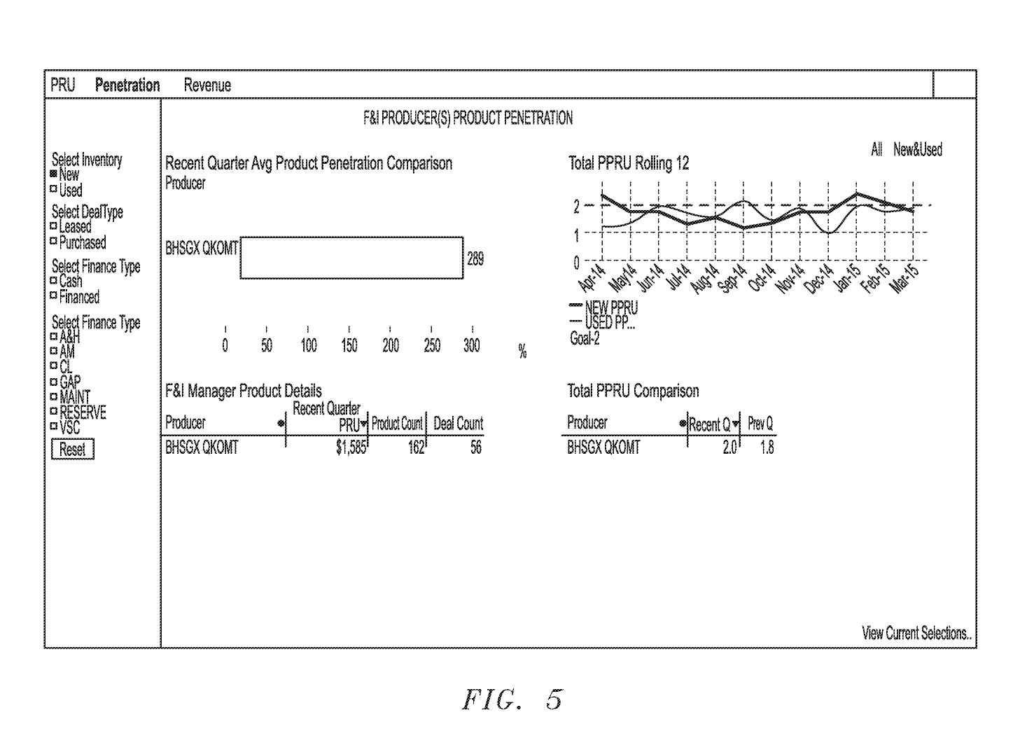

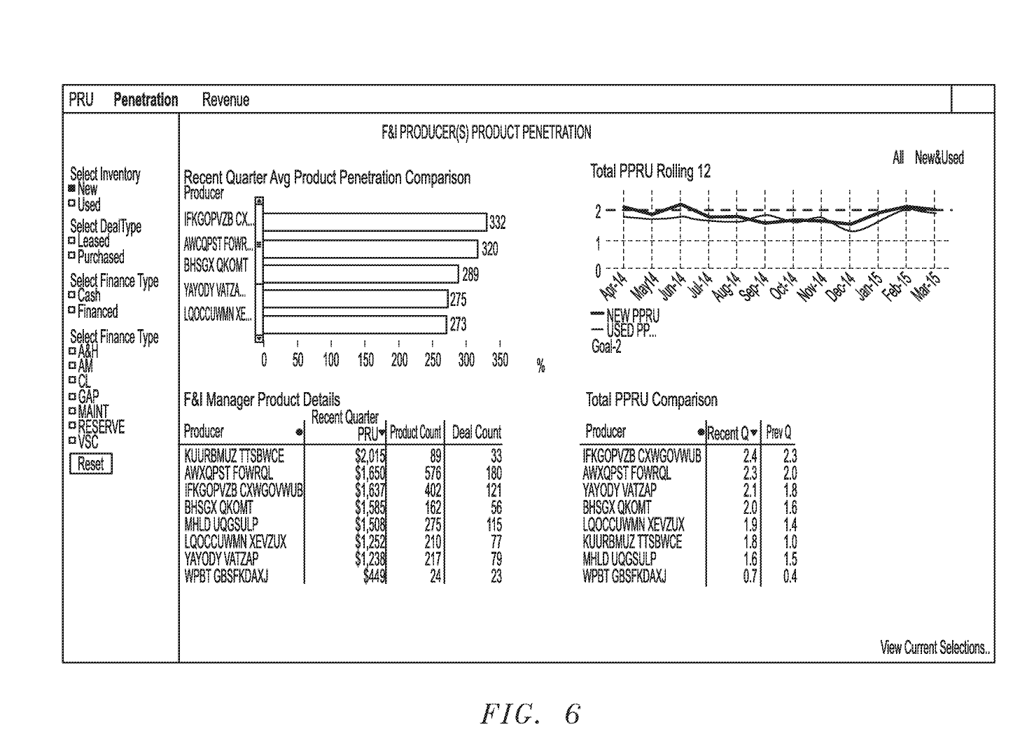

The moderator may then direct the manager attendees to the Penetration screen 210 and may begin with a single product as shown in FIG. 5. The penetration screen shows product penetration and product per retail unit (PPRU) 211. Once again, the moderator can compare new or used, leased or purchased, or cash or financed categories 212. The monitor may also elect to compare various products as shown on FIG. 6 which provides valuable information regarding the relative penetrations of the products within the market.

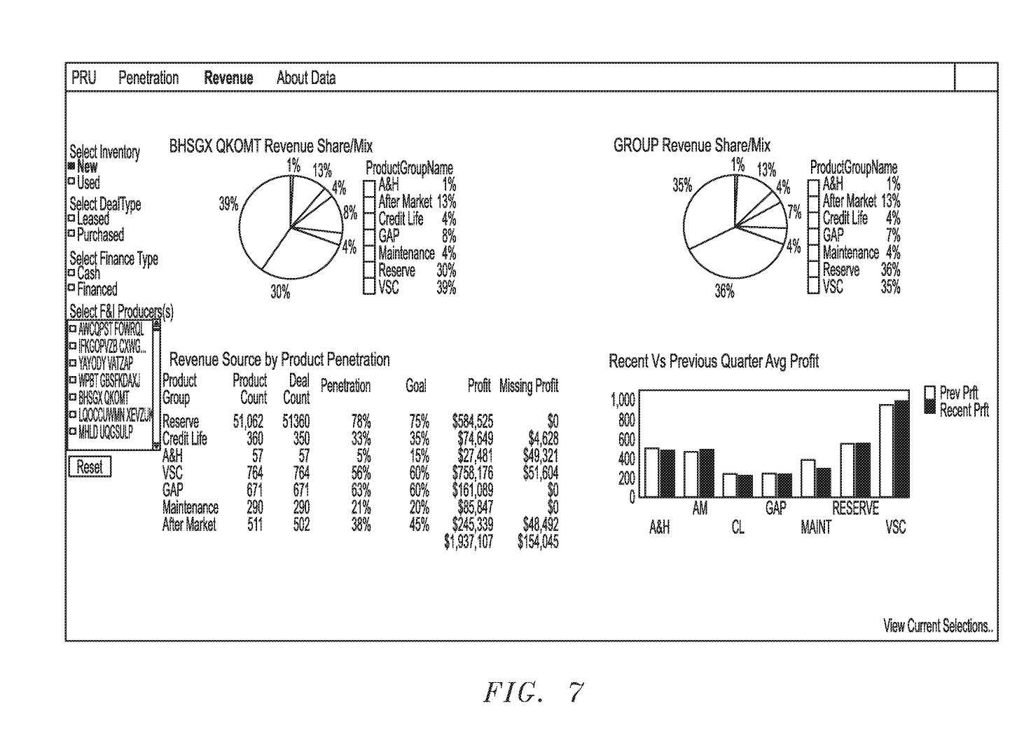

At this point, the moderator may direct the manager attendees to the Revenue screen, an example of which is shown in FIG. 7. From the Revenue screen, the managers will be able to view the revenue share/mix, the group revenue share/mix, the revenue source by product penetration, and the recent vs. previous quarter average profit. The moderator may emphasize why it is important to generate the majority of income from sources other than finance reserve 214.

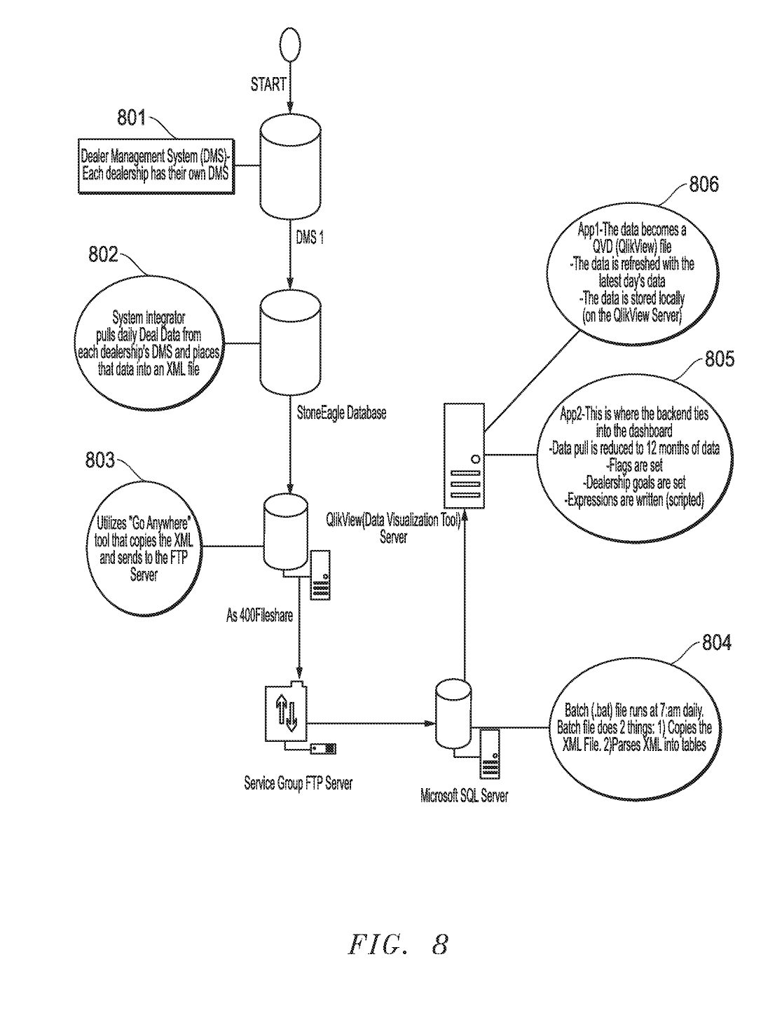

Referring now to FIG. 8, wherein one embodiment of the dataflow of the system of the present invention is presented. Each dealer collects information related to that dealership's sales in a dealer management system (DMS) 801. A system integrator pulls the sales information from the dealers' DMS systems and aggregates that information into an XML file 802. The aggregated sales information is then sent to the FTP server 803. At a pre-set time each day, the aggregated data is copied from the XML file and parsed into tables 804. The data is then converted to a QVD file 806 and stored locally for access and use by the user.

In at least one implementation, the user accesses the data through a graphical user interface (“GUI”) that allows users to interact with electronic devices with images rather than text commands. GUIs can be used in computers, hand-held devices, cell phones, tablets, and any other desired device. A GUI represents the information and actions available to a user through graphical icons and visual indicators such as secondary notation, as opposed to text-based interfaces, typed command labels or text navigation. The actions are usually performed through direct manipulation of the graphical elements.

In at least one embodiment, the system can be used to allow finance managers to receive training to improve performance using moderated virtual or face-to-face sessions. One skilled in the art will appreciate that although the system is exemplarily used for improving the performance of finance managers, the system can also be used for other purposes.

The system can include a network and, in at least one implementation, the network can be used to connect the various parts of the system to one another. The network exemplarily includes the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network includes one or more cellular RF networks and/or one or more wired and/or wireless networks such as, but not limited to, 802.xx networks, Bluetooth access points, wireless access points, IP-based networks, or the like. For example, the network can include cloud based networking and computing. The network can also include servers that enable one type of network to interface with another type of network.

The system can include system integrator databases. In at least one implementation, the system integrator databases can include any system capable of storing and retrieving the desired data files. For example, the system integrator databases can include an electronic database capable of electronically storing data. For example, the system integrator database can include memory or memory banks. Additionally or alternatively, the system integrator databases can include processors or other logic devices capable of executing software or carrying out other computer algorithms. The system integrator databases can allow a user to access the hardware of the user database for remote computing or for information retrieval.

The system can include a monitor and/or an organization that provides a monitor. In particular, the monitor works in conjunction with the management application to guide the managers through the training.

One skilled in the art will appreciate that the invention may be practiced in network computing environments with many types of computer system configurations, including personal computers, hand-held devices, mobile phones, multi-processor systems, microprocessor-based or programmable consumer electronics, network pcs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of systems for improving management performance known in the art, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A system for improving managers' performance, comprising:
one or more system integrator databases configured to remove data from dealer management systems; and
one or more processors configured to process the data into an XML file, transfer the XML file to a separate server, parse the XML files into tabular form, apply rules to filter the data, and display the data to a user.

2. The system of claim 1, wherein the user is a monitor conducting a workshop with two or more managers from the same dealer group;
the monitor displays the data filtered by productivity to the two or more managers;
the monitor displays the data filtered by product penetration to the two or more managers; and
the monitor displays the data filtered by revenue to the two or more managers.

3. The system of claim 1, wherein the user is a monitor conducting a workshop with two or more managers from different dealer groups;
the monitor displays the data filtered by productivity to the two or more managers;
the monitor displays the data filtered by product penetration to the two or more managers; and
the monitor displays the data filtered by revenue to the two or more managers.

4. The system of claim 1, wherein the user is a monitor conducting a workshop with two or more managers from the same dealer group and the two or more managers are located in a separate physical location from the monitor.

5. The system of claim 1, wherein the user is a monitor conducting a workshop with two or more managers from the same dealer group;
the monitor displays the data filtered by productivity to the two or more managers and the two or more managers are ranked on the basis of their respective productivity.
